(19) United States
(12) Patent Application Publication
(10) Pub. No.: US 2006/0161767 A1
(43) Pub. Date: Jul. 20, 2006

(54) Execution method and architecture of multiple-program-banks firmware

(76) Inventors: Yu-Hsien Wang, Jhubei City (TW); Chanson Lin, Jhubei City (TW); Hunk Hung, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/052,084

(22) Filed: Feb. 8, 2005

(30) Foreign Application Priority Data
Dec. 24, 2004 (TW) 93140474

(51) Int. Cl. G06F 15/177

(52) U.S. Cl. 713/100

(57) ABSTRACT

An execution method and architecture of multiple-program-banks firmware are proposed. The firmware is divided into multiple program banks stored in a nonvolatile memory. The program banks are also stored in a RAM. A No1 Bank manages the execution of these program banks. Programs of the program banks and updated codes of common programs can be modified at any time via an external interface bus. The execution method and architecture of multiple-program-banks firmware can accomplish better performance of program execution, and can change the content of a firmware program to enhance the flexibility of firmware.

### BACKGROUND OF THE INVENTION

1. Field of the Invention

The present invention relates to an execution method and architecture of firmware and, more particularly, to an execution method and architecture of multiple-program-banks firmware.

2. Description of Related art

Recently, consumer electronics, especially for devices having microprocessors such as digital still cameras (DSC), smart cards, communications devices and game machines, have become the main force for driving the growth of the semiconductor and electronic industry. Added with applications in car such as engine control and anti-braking system (ABS) and emerging applications such as electronic chip lock, global positioning system (GPS), cruise control, power window, thermostat air conditioning and electric massage chair, the usage of microprocessor gets more and more.

In the prior art, the instruction set executed by a microprocessor is a program arranged by a firmware. As shown in FIG. 1, a microprocessor 1 transmits an address signal to a read only memory (ROM) 2 via an address signal line. The ROM stores a firmware program. When the address signal reaches an address in the ROM, an instruction or data is transmitted to the microprocessor 1 or data obtained through operation of the microprocessor 1 is transmitted to the address for storage. Because the address of the firmware program in the ROM is fixed and the capacity of the ROM is very small, the size of the firmware program is limited, and the firmware program code can't be updated in response to application change.

Accordingly, the present invention aims to propose an execution method and architecture of multiple-program-banks firmware, which can accept external instructions to modify the content of the firmware. Moreover, the firmware program can manage itself to accomplish the optimization of program execution.

### SUMMARY OF THE INVENTION

An object of the present invention is to use a storage device for storing program banks of firmware program. Because the storage address is not fixed and the storage capacity is large, the firmware program is not limited by capacity and fixed address. Therefore, firmware programs with more functions can be developed out, and high expansibility can be accomplished.

Another object of the present invention is to provide an execution method and architecture of multiple-program-banks firmware, which can accept commands of an external device via an external interface bus to modify the program content so as to make modification of firmware program easy.

Yet another object of the present invention is to provide an execution method and architecture of multiple-program-banks firmware, which can store a firmware program in different program banks with a No1 bank managing execution of the firmware program to accomplish self management of program and better execution efficiency.

The present invention proposes an execution architecture and method of multiple-program-banks firmware applied to an operation system having a microprocessor. The execution architecture of multiple-program-banks firmware comprises a common program ROM connected to the microprocessor and storing a firmware program, a memory bank connected to the microprocessor and the common program ROM and capable of temporarily storing several instruction sets, and a program bank storage device connected to the memory bank and storing several program banks. The execution method of multiple-program-banks firmware comprises the steps of: a microprocessor starting reading a firmware program stored in a common program ROM, storing firmware program banks originally stored in a program storage device into a memory bank, and the microprocessor executing the firmware program.

### BRIEF DESCRIPTION OF THE DRAWINGS

The various objects and advantages of the present invention will be more readily understood from the following detailed description when read in conjunction with the appended drawing, in which:

FIG. 1 is an execution architecture diagram of firmware program in the prior art;

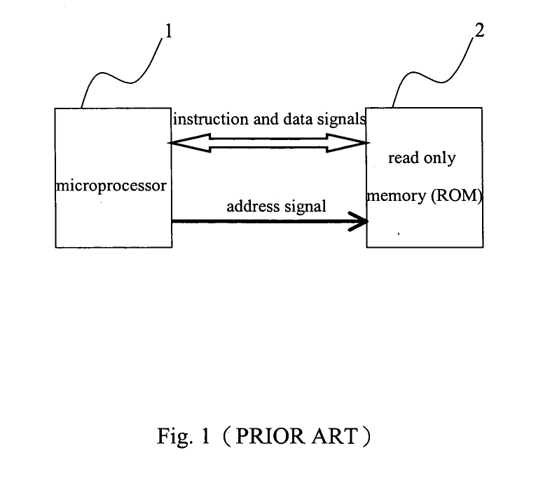

FIG. 2 is an execution architecture diagram of firmware program of the present invention;

FIG. 3 is an execution flowchart of firmware program of the present invention; and

FIG. 4 is another execution architecture diagram of firmware program of the present invention.

### DETAILED DESCRIPTION OF THE PREFERRED EMBODIMENTS

The present invention can split a firmware program executed on a computer into multiple program banks and store them into a memory bank. A No1 bank is then used to manage execution of these program banks to accomplish expansibility and self management.

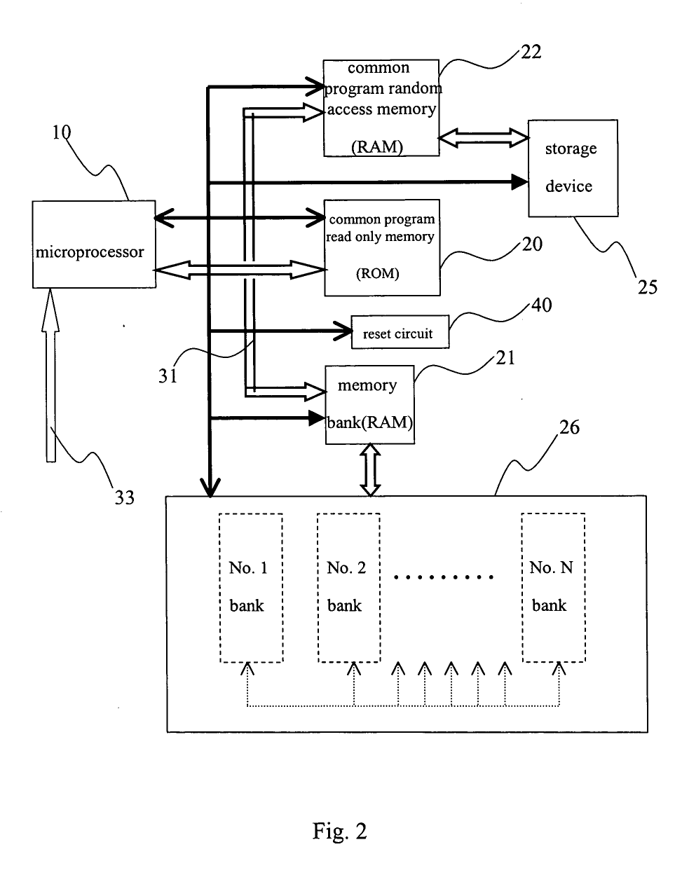

As shown in FIG. 2, an execution architecture of multiple-program-banks firmware of the present invention comprises a flash memory 26, a memory bank 21, a common program ROM 20, a common program random access memory (RAM) 22, a storage device, and a reset circuit 40. The flash memory 26 has N program banks each storing part of firmware program codes. The memory bank 21 is connected to the flash memory 26. The memory bank 21 is a static random access memory (SRAM) and can temporarily store firmware program codes of the program banks. The common program ROM 20 is connected to the flash memory 26 and a microprocessor 10 via a bus 31. The common program ROM 20 stores common program codes for controlling the procedures in the firmware program so that the microprocessor 10 can read instruction, read data and store data. The common program random access memory (RAM) 22 is connected to the common program ROM via the bus 31, and can temporarily store updated codes of common program of firmware. The storage device 25 is connected to the common program RAM 22, and stores updated codes of the firmware program. The reset circuit 40 is connected to the microprocessor 10 and can rest the microprocessor 10. The flash memory 26 is arranged by the firmware program into multiple program banks: No1 bank, No2 bank . . . to No N bank. The above program banks belong to the same firmware program. Each program bank stores part of program codes of the firmware.

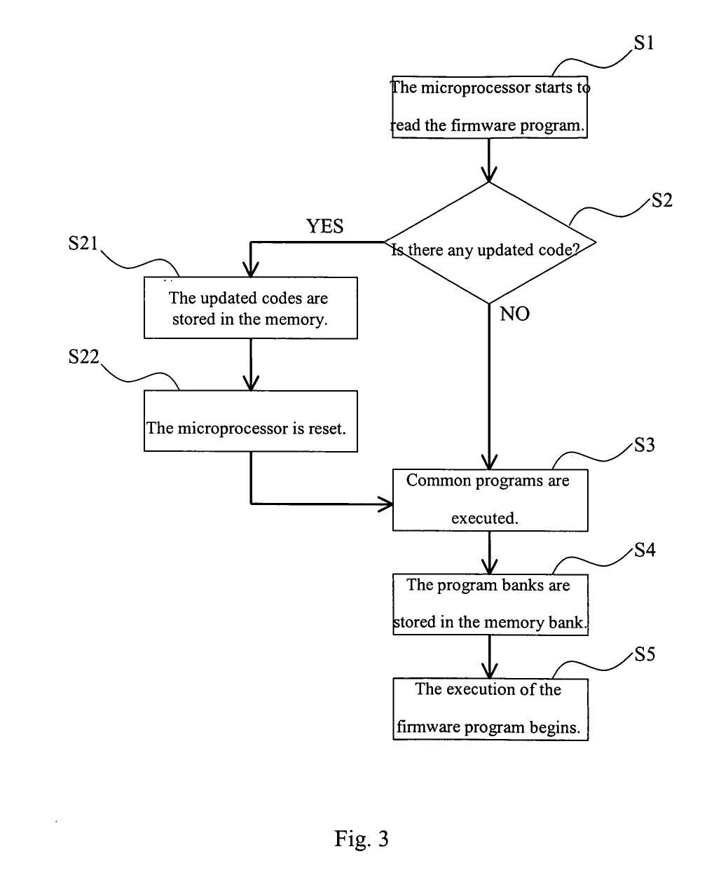

FIG. 3 is an execution flowchart of firmware program of the present invention. First, the microprocessor starts to read the firmware program stored in the common program ROM 20 (Step S1). The microprocessor 10 then executes a detection procedure to determine whether there is any updated code of the firmware program in the storage device 25 (Step S2). If the answer is yes, the updated codes are read and stored into the common program RAM 22 (Step S21). Next, the microprocessor is reset to read common programs of the firmware stored in the common program ROM 20 and the common program RAM 22 (Step S22). The common programs are then executed (Step S3). The common programs are main execution codes of the firmware. Subsequently, the firmware program stores N program banks in the flash memory 26 into the memory bank 21 so that the execution speed of the firmware won't be affected (Step S4). Finally, the execution of the firmware program begins to finish the installation of the whole operation system. In Step S2, if the answer is no (there is no updated codes of the firmware program in the storage device 25), Step S3 is jumped to for executing the common programs. Besides, execution actions of said firmware program by the microprocessor 21 include reading instruction, reading data and storing data.

In Step S4, part of the firmware program is split into several blocks stored in the flash memory 26. The main part of the firmware program is stored in the common program ROM 20, and other part of the firmware program is separated into different functions stored in No1 bank, No. 2 bank . . . and No N bank. The No1 bank is used to manage execution of the firmware program. Moreover, the firmware program codes in the common program part include the following pseudo code:

If jump bank is registered

Jump to what bank

When jumping to another program bank like No 4 bank for execution, the execution codes stored in the No 4 bank will be transmitted from the memory bank 21 to the microprocessor 10 according to the last in first out (LIFO) or first in first out (FIFO) rule. During execution of the firmware program codes, at which program bank the program is executed will be recorded to facilitate tracking of the present program execution position.

Furthermore, the microprocessor 10 can accept commands of an external device via an external interface bus 33 to transmit new program codes from the memory bank 21 to a specified address for modifying the firmware program codes, or updated codes of the common programs are stored into the storage device through the common program RAM 22. The object of modifying program by using the same architecture can thus be accomplished to solve the problem that the firmware can't be expanded or updated in the prior art.

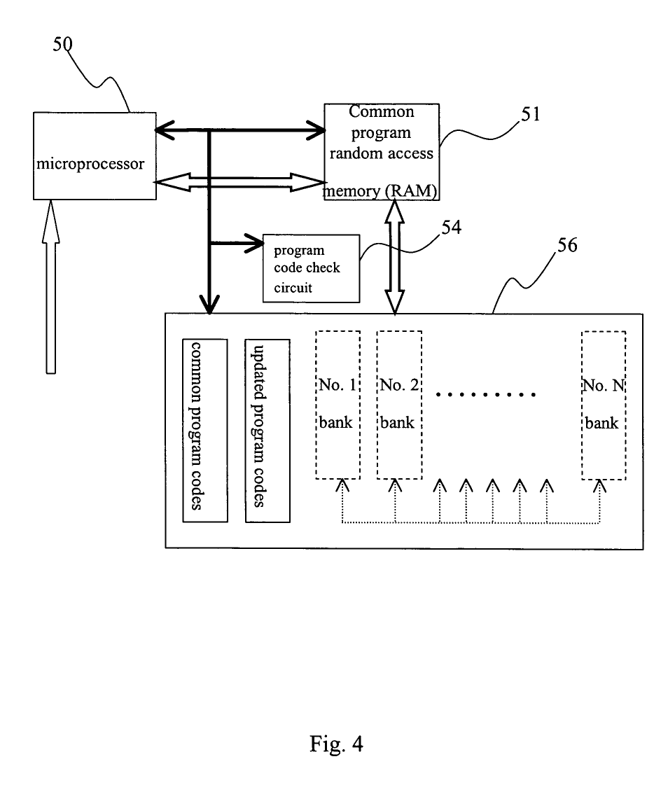

As shown in FIG. 4, another execution architecture of multiple-program-banks firmware of the present invention comprises a flash memory 56, a common program RAM 51, and a program code check circuit 54. The flash memory 56 stores a firmware program code. The common program RAM 51 is connected to the flash memory 56. The common program RAM 51 is an SRAM and can temporarily store firmware program codes. The program code check circuit 54 is a circuit for determining whether the common program RAM has the firmware program codes. The firmware program codes include common program codes, updated program codes, and N program banks. The common program codes are used for controlling the procedures in the firmware program so that a microprocessor 50 can read instruction, read data and store data. The N program banks include No1 bank, No2 bank . . . to No N bank. The above program banks belong to the same firmware program. Each program bank stores part of program codes of the firmware.

Under the execution architecture of multiple-program-banks firmware shown in FIG. 4, after an operation system having a microprocessor is activated, the program code check circuit 54 transmits a signal to the common program RAM 51 to let it download the firmware program in the flash memory 56. The firmware program includes common program codes, updated program codes, and N program banks. After the download is finished, the program code check circuit 54 transmits another signal to the microprocessor 50 to let it start reading the firmware program in the common program RAM 51. The firmware program executes the common program codes (the main execution codes) and the updated program codes. The execution way of the multiple program banks is the same as stated above.

To sum up, the execution architecture of firmware of the present invention arranges a firmware program into multiple blocks stored in multiple program banks and uses a No 1 bank for self management of the program. Moreover, the microprocessor can accept commands of an external device to modify the program content. Therefore, the present invention can effectively solve the problem that the firmware program has a fixed address and can't be changed in the prior art. Moreover, the present invention provides an architecture of firmware program for storing a firmware program in a nonvolatile memory. Because the storage capacity is large, the amount of program codes can be increased.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An execution architecture of multiple-program-banks firmware used in an operational system having a microprocessor, said execution architecture of multiple-program-banks firmware comprising:
a common program ROM connected to said microprocessor and storing a firmware program;
a memory bank connected to said microprocessor and said common program ROM and capable of temporarily storing several instruction sets; and
a program bank storage device connected to said memory bank and having several program banks which store part of firmware program codes.

2. The execution architecture of multiple-program-banks firmware as claimed in claim 1, wherein said memory bank is an SRAM.

3. The execution architecture of multiple-program-banks firmware as claimed in claim 1, wherein execution actions of said firmware program include reading instruction, reading data and storing data.

4. The execution architecture of multiple-program-banks firmware as claimed in claim 1, wherein said firmware program has a program code of the main control flowchart.

5. The execution architecture of multiple-program-banks firmware as claimed in claim 1, wherein said storage device is a flash memory.

6. The execution architecture of multiple-program-banks firmware as claimed in claim 1 further comprising a common program RAM, which is connected to said common program ROM and can temporarily storing updated codes of said firmware program.

7. The execution architecture of multiple-program-banks firmware as claimed in claim 6, wherein said common program RAM is an SRAM.

8. The execution architecture of multiple-program-banks firmware as claimed in claim 6 further comprising a storage device, which is connected to said common program RAM and stores said updated codes.

9. The execution architecture of multiple-program-banks firmware as claimed in claim 1 further comprising a reset circuit, which is connected to said microprocessor and can reset said microprocessor.

10. An execution method of multiple-program-banks firmware comprising the steps of:
a microprocessor starting reading a firmware program stored in a common program ROM;
storing firmware program banks originally stored in a program storage device into a memory bank; and
said microprocessor executing said firmware.

11. The execution method of multiple-program-banks firmware as claimed in claim 10 further comprising the step of an external interface device storing modified program codes into said program storage device through said microprocessor.

12. The execution method of multiple-program-banks firmware as claimed in claim 10, wherein said program storage device is connected to said memory bank and has several program banks, and each said program bank is part program code of said firmware program.

13. The execution method of multiple-program-banks firmware as claimed in claim 10 further comprising the following steps before said microprocessor starts reading said firmware:
reading updated codes into a common program RAM and resetting said microprocessor if there are updated codes of said firmware stored in a storage device; and
continuing reading said firmware program if there are no updated codes.

14. The execution method of multiple-program-banks firmware as claimed in claim 13, wherein a reset circuit is connected to said microprocessor and can reset said microprocessor.

15. The execution method of multiple-program-banks firmware as claimed in claim 13 further comprising the step of reading said firmware program of said common program ROM and said updated codes of said common program RAM after resetting said microprocessor.

16. The execution method of multiple-program-banks firmware as claimed in claim 10, wherein said firmware program includes main execution program codes.

17. The execution method of multiple-program-banks firmware as claimed in claim 10, wherein execution actions of said firmware program include reading instruction, reading data and storing data.

18. The execution method of multiple-program-banks firmware as claimed in claim 10, wherein said firmware program banks has a No1 bank for managing execution of said firmware program banks.

19. An execution architecture of multiple-program-banks firmware used in an operational system having a microprocessor, said execution architecture of multiple-program-banks firmware comprising:
a common program RAM connected to said microprocessor and capable of temporarily storing several instruction sets;
a program bank storage device connected to said common program RAM and said microprocessor, said program bank storage device having a firmware program code; and
a program code check component connected to said common program RAM, said program bank storage device and said microprocessor.

20. The execution architecture of multiple-program-banks firmware as claimed in claim 19, wherein said common program RAM is an SRAM.

21. The execution architecture of multiple-program-banks firmware as claimed in claim 19, wherein said program bank storage device is a flash memory.

22. The execution architecture of multiple-program-banks firmware as claimed in claim 19, wherein said firmware program code includes common program codes, updated program codes and several program banks.

23. The execution architecture of multiple-program-banks firmware as claimed in claim 19, wherein said program code check component is an IC, which can determine whether said common program RAM has accessed said firmware program code.
